(19) United States
(12) Patent Application Publication
(10) Pub. No.: US 2019/0037460 A1
(43) Pub. Date: Jan. 31, 2019

(54) METHODS AND SYSTEMS FOR CHANNEL SWITCHING IN A WIRELESS COMMUNICATION SYSTEM

(71) Applicant: QUALCOMM Incorporated, San Diego, CA (US)

(72) Inventors: Abhijit BHATTACHARYA, Bangalore (IN); Yanjun SUN, San Diego, CA (US); Peerapol TINNAKORNSRISUPHAP, San Diego, CA (US); Brian Michael BUESKER, San Diego, CA (US); Saiyiu Duncan HO, San Diego, CA (US); Rajesh KUMAR, San Diego, CA (US); Rohit KAPOOR, Bangalore (IN)

(21) Appl. No.: 15/662,210

(22) Filed: Jul. 27, 2017

(51) Int. Cl. H04W 36/08

(52) U.S. Cl. CPC H04W 36/08

(57) ABSTRACT

Disclosed are methods and systems for a wireless communication network including detecting a trigger to switch a serving channel at a first access point, and communicating a first channel switch message from the first access point to a second access point. The first access point may be in a downstream and/or upstream or communication flow in relation to the second access point. The process may include communicating a first Channel Switching Announcement (CSA) message from the second access point to at least one client of the second access point, where the least one client is one of a plurality of clients receiving internet connectivity through a series of communication flows including a data flow through the second access point. The process further includes revising a time to switch channel information included in the first channel switch message, where the first CSA message includes the revised time to switch channel information.

### TECHNICAL FIELD

This application relates generally to wireless communication, and more specifically to systems and methods for channel switching in a wireless communication system.

### BACKGROUND

Wireless communication systems are widely deployed to provide various types of communication content such as voice, video, packet data, messaging, broadcast, and so on. Wi-Fi or WiFi (e.g., IEEE 802.11) is a technology that allows electronic devices to connect to a wireless local area network (WLAN). A WiFi network may include an access point (AP) that may communicate with one or more other electronic devices (e.g., computers, cellular phones, tablets, laptops, televisions, wireless devices, mobile devices, “smart” devices, etc.), which can be referred to as stations (STAs) or clients. The AP may be coupled to a network, such as the Internet, and may enable one or more STAs to communicate via the network.

Users continue to demand greater and greater capacity and operating range from their wireless networks. For example, video streaming over wireless networks is becoming more common and uninterrupted streaming is highly desired. In order to address the operating range by which the STAs (i.e. clients) may communicate to the AP, a device in the system may operate as a range extender (RE). In a network configuration, there may be several RE's. An RE may be in a wireless connection with a central AP (CAP) over a particular channel. The function of range extending may also be carried out by a device that is also performing functions of an AP. The CAP is connected to a wide area network (WAN). In turn, the RE extends the operating range of the CAP through one or more wireless connections between the CAP and RE. An STA may be receiving internet services via a wireless communication channel established between the RE and the STA.

The quality of a wireless channel may be impacted over time, and as an example due to over the air interference from other devices operating in the same area. In an example, the quality of the serving channel may be measured based on the error rate of the communication channel. When the quality of the serving channel is degraded below an acceptable level, the CAP or the RE may go through a process for selection of a new serving channel, and subsequently switching to the target serving channel. Many wireless networks utilize carrier-sense multiple access (CSMA) to share a wireless medium measured by a frequency spectrum bandwidth. With CSMA, a device may listen on a particular channel to determine whether another transmission is in progress. If the channel is idle for at least a period of time, the device may attempt a transmission over the channel. The device may wait for a period of time in a re-attempt for finding the channel idle or may switch to find another idle channel. While a STA is in a communication session, the channel switching process, however, is desired to be performed in a manner such that it does not interrupt or degrade the communication session.

A Channel Switching Announcement (CSA) message in accordance with one or more processes articulated in a relevant IEEE Standard (e.g. 802.11h) may be used for the purpose of channel switching. Considering a STA that is in direct wireless communication with a CAP, the use of CSA may not present a significant issue; however, in a system where a CAP and one or more RE's are involved in providing the services to the STA, a simple use of CSA is insufficient to provide a seamless switching of the channel without interruption of the services provided to the STA. Therefore, there is a need for an improved channel switching process in a communication system involving a CAP and at least one RE.

### SUMMARY

Method and apparatus for wireless communication in a network configuration are disclosed. The method and apparatus include detecting a trigger to switch a serving channel at a first access point, and communicating a first channel switch message from the first access point to a second access point. The first access point may be in a downstream and/or upstream communication flow in relation to the second access point. The method further includes communicating a second channel switch message from the first or second access point to a central access point. The central access point may be connected to wide area network for providing internet connectivity to a plurality of clients through a series of communication flows from the first and second access points. At least one of the first and second access points may be operating as a range extending access point. The process further includes revising a time to switch channel information included in the first channel switch message, and including the revised time to switch channel information in the second channel switch message. The process may include communicating a first Channel Switching Announcement (CSA) message from the second access point to at least one client of the second access point, where the least one client is one of a plurality of clients receiving internet connectivity through a series of communication flows including a data flow through the second access point. The process further includes revising a time to switch channel information included in the first channel switch message, where the first CSA message includes the revised time to switch channel information. The process further includes communicating a second Channel Switching Announcement (CSA) message from the first access point to at least one client of the first access point, where the least one client is one of a plurality of clients receiving internet connectivity through the series of communication flows including a data flow through the first access point. The process flow may further include switching from a serving channel to a target channel at essentially the same time at the central access point, the first and second access points, and the plurality of clients receiving internet connectivity through the series of communication flows. The process may include selecting a target channel to be included in the first channel switch message. The process flow may include communicating periodically channel measurements reports from the first and second access points to the central access point, consolidating the measurement reports at the central access point, and communicating a list of target channels to the first and second access points, where the selection of the target channel is based on one or more quality and preference metrics associated with the list of target channels. The process flow may include communicating a prep-to-switch-channel-message from the central access point to at least one of the first and second access points, detecting the trigger to switch the serving channel to be an urgent trigger to switch channel, and rejecting the prep-to-switch-channel-message from the central access point by at least one of ignoring the prep-to-switch-channel-message and sending a reject prep-to-switch-channel-message. The method and apparatus further include performing a band steering operation for at least a client being identified as a Channel Switching Announcement (CSA) un-friendly client at the first access point and/or the second access point upon receiving the prep-to-switch-channel-message.

### BRIEF DESCRIPTION OF THE DRAWINGS

FIG. 1 is a diagram that illustrates a network configuration with a number of wireless devices that may be operated in accordance with various aspects of the disclosure.

FIG. 2 illustrates a process for switching a channel between two wireless devices.

FIG. 3 illustrates a process flow among a number of wireless devices in a network configuration in accordance with various aspects of the disclosure.

FIG. 4 illustrates a process flow among a number of wireless devices in a network configuration in accordance with various aspects of the disclosure.

FIG. 5 illustrates a process flow among a number of wireless devices in a network configuration in accordance with various aspects of the disclosure.

FIG. 6 illustrates a wireless device with various components that may be utilized in any of the devices identified in FIGS. 1-5 that are able to perform wireless communication.

### DETAILED DESCRIPTION

Various aspects of the novel systems, apparatuses, and methods are described more fully hereinafter with reference to the accompanying drawings. Various disclosed methods and apparatuses may, however, be embodied in many different forms and should not be construed as limited to any specific structure or function presented throughout. Wireless access network technologies may include various types of wireless local area access networks (WLANs). A WLAN may be used to interconnect nearby devices together, employing widely used access networking protocols. The various aspects described herein may apply to any communication standard, and any member of the IEEE 802.11 family of wireless protocols. In some implementations, a WLAN includes various devices which access the wireless access network. For example, there may be: access points (“APs”) and clients (also referred to as stations, or “STAs”). In general, an AP serves as a hub or a base station for the STAs in the WLAN. An STA may be a laptop computer, a personal digital assistant (PDA), a mobile phone, etc. In an example, a STA connects to an AP via a Wi-Fi (e.g., IEEE 802.11 protocol such as 802.11ac and 802.11n) compliant wireless link to obtain general connectivity to the Internet or to other wide area access networks. In some implementations a STA may also be used as an AP. In another implementation a STA may also operate as an RE. One or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, a Node-B (Base-station), or any other suitable device that is configured to communicate via a wireless medium.

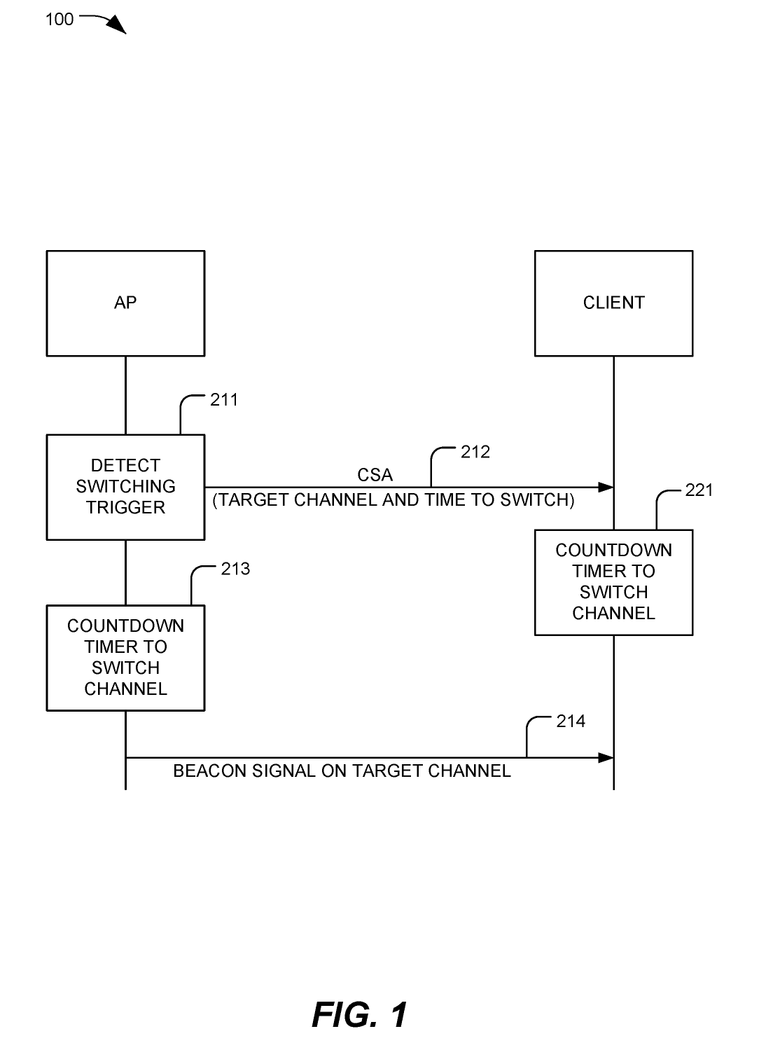

FIG. 1 is a diagram that may be used to illustrate various novel aspects of the disclosure. A network configuration 100 is shown as an exemplary communication network where a number of clients (e.g. STAs) may receive services by having a wireless connection on a particular channel. The network configuration 100 is shown to include a central AP (CAP) 110 connected to wide area network (WAN) for access to internet services. The network configuration 100 also includes as an exemplary configuration two additional APs 111 and 112. A characteristic common to CAP 110 and APs 111 and 112 is the ability to provide wireless communication over a common frequency band, although each may also have the ability to provide wireless communications over additional and different frequency bands. Another characteristic common to CAP 110 and APs 111 and 112 is the ability to maintain a wireless communication link with each other as well as maintaining wireless communication links to a number of clients (i.e. STAs). The communication links with the clients and between the CAP and APs may be on a common frequency band, in an exemplary configuration. For example, the communication links between CAP 110, AP 111, AP 112, clients 101 and 102 are shown to be over a common frequency channel X, while the communication link between CAP 110 and a client 103 is over a channel Y, and the communication link between AP 111 and a client 104 is over a channel Z. Although channels Y and Z are identified to be different, clients 103 and 104 may be receiving services over the same frequency channels from different APs. The network configuration 100 includes devices that are capable of operating in a multi-band environment. For simplicity, CAP 110, APs 111 and 112 are shown to be able to operate in two different frequency bands. Network configuration 100 may also allow and provide for client devices of operating in several frequency bands. In the exemplary network configuration 100, CAP 110, APs 111 and 112 are able to operate in the frequency bands commonly referred to as “5G” and “2.4G” radio frequency bands. For devices operating in accordance with various 802.11 Standards, a number of frequency bands are available and each may have specific channel bandwidth and other transmission characteristics requirements. A complete listing of the frequency bands and the outlined characteristics of the channels frequency bandwidths is publicly available. The operating requirements within such frequency bands may be different in various countries. For example, 5G and 2.4G frequency bands may respectively have a specific number of available frequency channels where each channel may be identified by a channel ID. The frequency channels identified as X, Y and Z are such channel IDs. Considering a device may be able to operate within several different frequency bands, the selection of the frequency band(s) for a particular service within a network configuration may be based on a prearranged plan or dynamically changed depending on various dynamic factors such as traffic congestion level, number of users, interference level, etc.

Referring to FIG. 1, the APs 111 and 112 may operate as range extenders (RE) for the services (e.g. internet access) provided by CAP 110. The operation of CAP 110 over a wireless link may be limited to certain over the air propagation geography. As a result, the clients that are located outside of such propagation geography of CAP 110 may not be able to maintain a wireless link with CAP 110 at an expected link quality. The CAP 110 may be connected, for example, to a wired cable for connection to WAN (i.e. internet) and as a result may be located in a utility room of a building, while the clients are geographically distributed in the building or the open space around the building. Placing the APs 111 and 112 in a proximity to CAP 110 and operating them in at least one aspect as range extenders (REs), allows clients that are further away to access WAN services through CAP 110. As such, as shown in network configuration 100, APs 111 and 112 may operate respectively as range extenders RE1 and RE2. In one example, RE1 is extending the range for client 101 to have access to internet services through CAP 110. In another example, RE2 is extending the range via RE1, which in turn is extending the range for client 102 to have internet services through CAP 110.

In the exemplary embodiments shown in FIG. 1, clients 101 and 102 may be receiving internet services over use of a common channel X. The RE1 and RE2, in this example, are providing range extending operations while using channel X. Clients 101 and 102 are as a result receiving the internet services through CAP 110 and essentially RE1 and RE2, respectively, over channel X. Various possible configurations for use of available channels for providing communication services as well as extending the range are possible. Although not all configurations may be shown, a few other examples are shown and described. In another example, while use of channel X for range extending through RE1 and RE2 and providing internet services through CAP 110 for clients 101 and 102 are taking place, client 106 may be receiving internet services from CAP 110 through RE1 on channel W. In yet another example and similarly, client 107 may be receiving internet services from CAP 110 through RE2 on channel L. In yet another example and similarly, clients 108,109 and 119 may be receiving internet services from CAP 110 through RE1 and RE2 on channel K. In this configuration, multiple clients (e.g. 109 and 119) may be receiving services from a single AP (e.g. AP 112) on the same channel K. There may be many more clients receiving internet services through RE1 and RE2 with a WAN connection at CAP 110 on the same or various channels. Moreover, in the exemplary embodiments shown in network configuration 100, the functions of range extending through APs 111 and 112 are shown in relation to the 5G frequency band for simplicity of explanation. In practice, any possible frequency band for the operation of extending the range may be used and allowed by the network configuration 100, for example 2.4G frequency band.

Generally, each CAP 110, APs 111 and 112 perform periodic measurement about the quality of the wireless links. The quality of the wireless links may be impacted by a congestion level, interference, and other possible sources. In one aspect, the AP may go through a process of medium utilization measurement where it estimates a percentage of channel utilization in the medium. For example, if the estimated utilization is above a 50% threshold, the AP may decide to switch the channel from an existing channel to another channel. However, the AP may need to follow a particular process for switching to the new channel such that the client(s) receiving services over such an existing channel would not experience an interruption of services or at least the interruption is minimized.

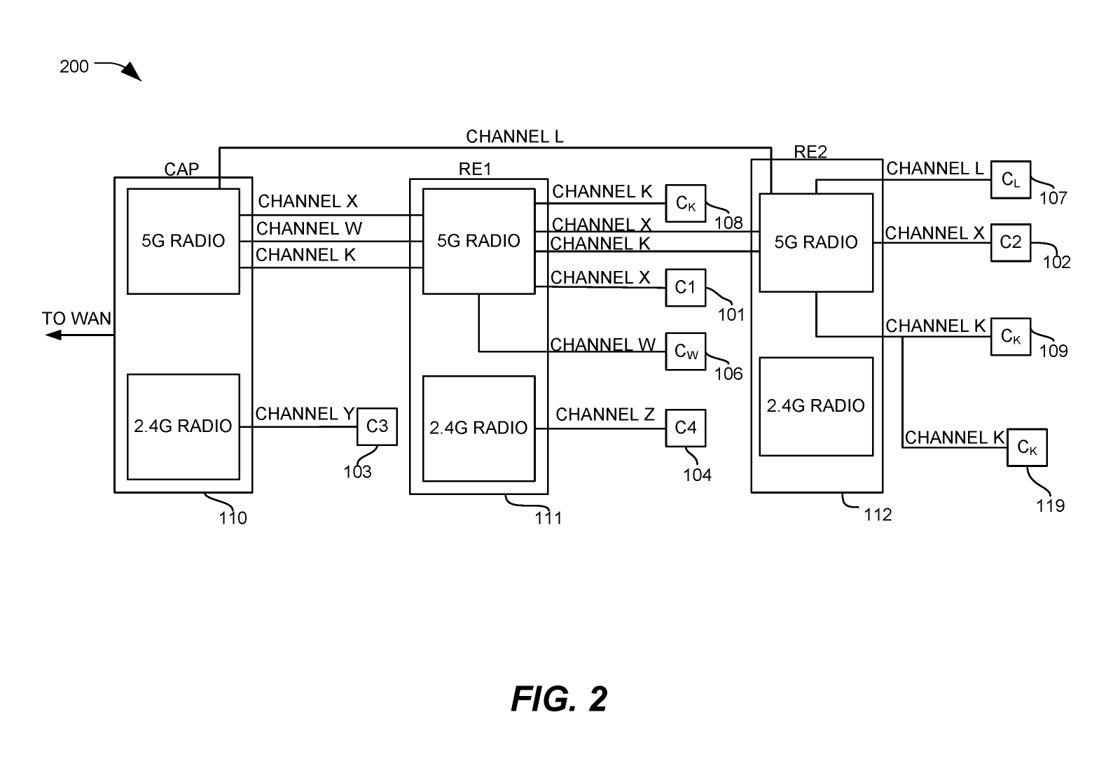

FIG. 2 depicts an exemplary process 200 commonly known as channel switch announcement (CSA) process that may be used for switching a channel between an AP and a client. At step 211, the AP may detect a switching trigger based on a medium utilization determination process to switch to another channel. A CSA message 212 is communicated to the client being serviced on the same channel by the AP. The CSA message 212 includes information about the target channel and the time to switch to the target channel. The AP also begins a countdown timer 213, and similarly, the client may be performing the same countdown timer 221 and preparing to switch to the target channel. After the countdown time has reached, a beacon signal 214 is communicated on the target channel. The client begins receiving the beacon signal 214 after its countdown timer 221 has expired. At such a point, both the AP and the client may continue to communicate on the new target channel, and effectively, a channel switch and announcement process has been completed between the AP and the client. The process 200 may take several hundreds of milliseconds. Assuming the client does not receive the CSA message 212, the client may eventually find the new channel by sending a probe request and rediscovering the AP on the new target channel which may take several seconds to complete, and a service interruption may be experienced by the client.

Referring now to FIG. 1, while providing services to clients that receive services through at least one RE, following the process 200 by each AP or CAP 110 for switching a serving channel to a new channel is inadequate. CAP 110 providing services on channel Y to client 103 or AP 111 providing services to client 104 on channel Z would not have any particular issue for switching to a new target channel if the flow of process 200 is followed, mainly because the impact of channel change is limited to only one AP and its client(s) being served on the same channel. However, CAP 110, AP 111 and AP 112 while operating as RE's following the process 200 to switch the services from the serving channel (e.g. channel X, L, W or K) to a new channel would result in interruption of services to at least one of the clients being serviced on the serving channel. The interruption of the service mainly is as a result of one range extending access point in the downstream or upstream communication flow attempting to change the serving channel from the existing serving channel to another channel, and another range extending access point in a common communication flow continuing the service on the existing serving channel. In the examples as shown, essentially, use of AP 111 and/or AP 112 as an RE to provide internet services from CAP 110 to clients would require a new and novel processes for channel switching in a network such as the network configuration 100, particularly when one RE is attempting to change the serving channel in a communication flow involving more than one REs.

Among CAP 110, AP 111 and AP 112, each AP may be making a trigger decision about switching the channel based on the locally observed measurements, and absent of any coordination, at least one of the clients receiving services on the same serving channel would suffer an interruption of the service for some time. The CAP 110, AP 111 and AP 112 may be performing and measuring a local medium utilization for a number of reasons for trigger of switching from a serving channel to a new channel, and a channel switching process may be followed in accordance with various aspect of the disclosure without causing an interruption of service to a client. The trigger of switching channel may be based on a local medium utilization measurement process that determines that the medium channel utilization has reached a threshold. Considering that the geographical locations of CAP 110, AP 111 and AP 112 may be widely distributed over a large area, each AP may experience a different medium utilization and interference level. The interference level or the medium utilization at a particular AP may unexpectedly reach a level that a channel switching process should begin rather urgently to avoid further deterioration of the channel medium and loss of services to a client. As such, an urgent trigger to switch the channel may be needed. In another aspect, the medium utilization level may be reaching a threshold or a level of interference is increasing in such a way that a channel switch trigger may be useful to prevent a near future interruption of services. In such a condition, a non-urgent trigger to switch the channel may be needed.

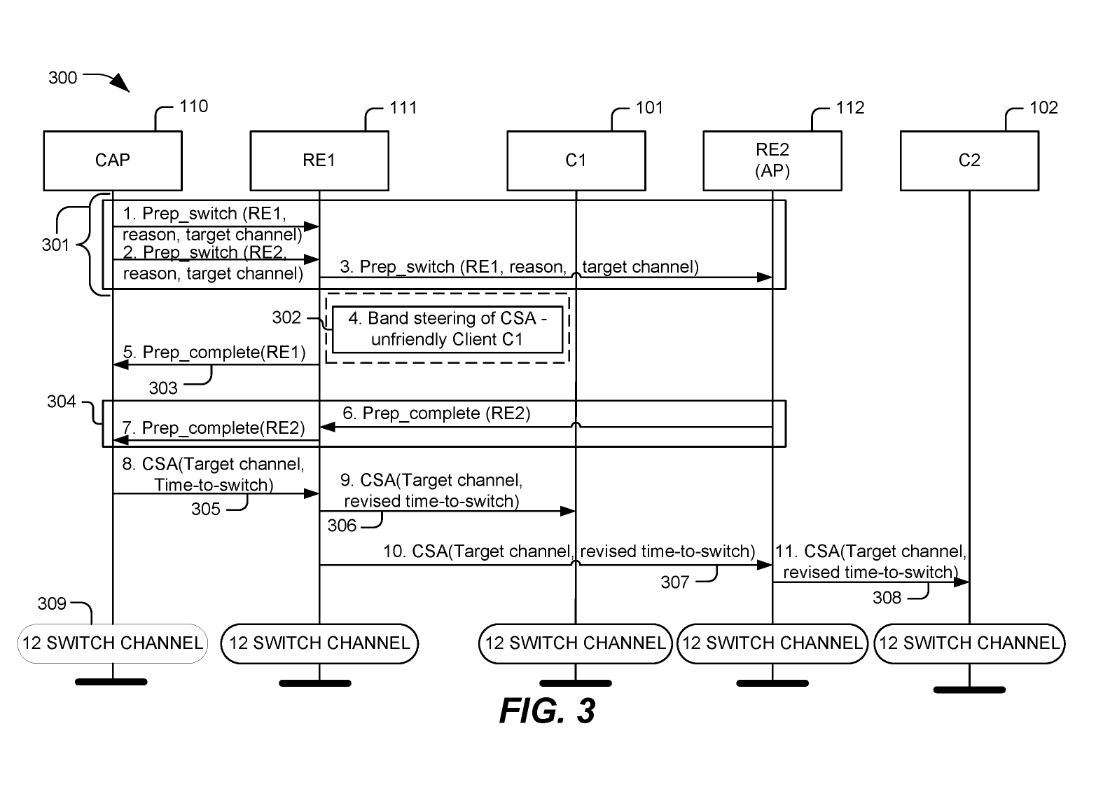

FIG. 3 depicts a process flow 300 and explained in relation to the network configuration 100 depicted in FIG. 1. In accordance with various aspect of the disclosure process flow 300 provides for non-urgent trigger to switch the serving channel for clients 101 and 102 (i.e. C1, C2) receiving internet services from CAP 110 through AP 111 and AP 112 operating respectively as RE1 and RE2. The clients C1 and C2 are receiving services over a common serving channel X, as an example. The wireless links from CAP 110 to RE1, and from RE1 to RE2 are also over the serving channel X, as an example. While referring to FIGS. 1 and 3, the trigger channel switch may be initiated by CAP 110. Initiating a trigger channel switch by CAP 110 may be in coordination among the CAP 110 and RE1 and RE2 (i.e. APs 111 and 112). Considering the process flow 300 is for non-urgent trigger channel switch, RE1 and RE2 may from time to time collect local channel utilization measurement and pass the information (not shown) to CAP 110. The CAP 110 may at a time determine that a channel switch needs to be triggered to avoid a possible interruption of services over the serving channel. In addition, in the event the trigger channel switch is determined to be needed by RE1 or RE2 based on their local medium utilization or interference measurement, the need to trigger a channel switch information is communicated (not shown) to CAP 110 at a time prior to the time that CAP 110 is initiating a trigger channel switch. Therefore, the decision to switch the channel may be made at CAP 110, RE1 or RE2. For non-urgent trigger channel switch, the process 300 begins at CAP 110.

Referring to FIG. 3, CAP 110 communicates a prep-to-switch-channel-message 301 to RE1 and RE2. The prep-message 301 may include a direction to RE1 and RE2 to prepare for switching to a target channel, identifying the target channel, and may possibly include a reason for switching the channel. The prep-message 301 may include two different messages, one for each of the RE1 and RE2. The prep-message to RE2 may be communicated through RE1 as shown. Since the channel trigger is, for example, for channel X, the entities operating to provide the internet service and to receive the service over the serving channel X would be impacted. As a result, RE1, RE2, C1 and C2 are shown to be involved in the process flow 300. Although the remaining message flow in the process 300 is shown for RE1 to follow through the process, RE1 may as an example decide upon receiving the prep-message 301 to steer some of its clients to a different channel frequency band based on certain criteria.

Clients may be categorized into CSA-friendly and CSA-unfriendly based on their past behavior in response to CSA messages. After an AP has switched to a new channel, if it does not find the client on the new channel within a predefined duration (typically a few hundred milliseconds) after switching, the client may be categorized as CSA-unfriendly. Otherwise, the client is categorized as CSA-friendly. There may be a number of reasons for a client not being able to switch to a new channel. An example of CSA-unfriendly clients would be clients that operate in accordance with certain 802.11 Standards that exclude the processes for an implementation of CSA. Considering that in a network configuration such as network configuration 100 many different devices may be operating while complying with different 802.11 Standards, some of the clients may be categorized as CSA-unfriendly and other as CSA-friendly. As such, as an exemplary processes, RE1 at process step 302 may decide to steer the CSA-unfriendly clients to a different frequency band through a process commonly known as frequency band steering after receiving prep-message 301. Similarly, RE2 may also go through a band steering process, although not shown.

The frequency band steering process may be used by an AP (i.e. RE1 or RE2) to move a client associated on one frequency band (e.g. 2.4G band) to another frequency band (e.g. 5G band). To carry out such a band steering with minimal service interruption to clients that are complying as an example with an IEEE 802.11 standard, the AP sends out a request to such clients. The request includes a target basic service set (BSS) in the new frequency band. When a client receives such a request, it responds to the AP indicating acceptance of the request, and re-associates with the AP on the target BSS. As such, the AP does not have to disassociate the client to perform the frequency band steering, thus saving time, and minimizing service disruption. For clients that do not support IEEE 802.11v, the frequency band steering is performed only when the client is not actively transferring data to avoid service interruption to such clients. To perform frequency band steering for such clients, the AP explicitly disassociates the client, installs a blacklist for the client on the serving channel, and rejects any attempt by the client to re-authenticate on the blacklisted channel. Thus, it forces the client that does not support IEEE 802.11v to naturally re-associate with the AP on the desired target frequency band.

Referring to FIG. 3, in order to serve the CSA-friendly clients, such as clients C1, the RE1 would send a prep-to-switch-channel-complete message 303 to CAP 110 indicating the preparation to switch to a new channel has been completed. Considering RE2 is also accepting to switch the serving channel X for its associated client C2, RE2 via RE1 would send a prep-complete message 304 to CAP 110. After receiving the prep-complete messages from the RE's, CAP 110 would generate and send a CSA message 305 to RE1 including the target channel and the time to switch the channel information. The RE1 upon receiving the CSA message 305 would communicate a CSA message 306 to its associated client C1 while revising the time to switch the channel information as compared to the time to switch information contained in message 305. The RE1 also upon receiving the CSA message 305 would communicate a CSA message 307 to RE2 while revising the time to switch channel information as compared to the time to switch information contained in message 305. The RE2 upon receiving the CSA message 307 would communicate a CSA message 308 to its associated client C2 while revising the time to switch channel information as compared to the time to switch information contained in CSA message 307.

The time to switch channel information may indicate how much time is remaining until the sender of the message is planning to switch to the new serving channel. Considering the message flow from one entity to another in the network configuration takes time, when an entity receives the time to switch channel information from another entity (e.g. RE1 from CAP, RE2 from RE1), before sending the information to another entity, the receiving entity adjusts the timing value by an amount to account for the fact that there was some delay for the message to reach the receiving entity from a transmitting entity. As such, when RE1 sends message 306 to C1, the time information in the message is revised as compared to the time information received in message 305. Except for CAP 110 that originally initiated the process, every other entity that receives the message in turn will revise the time to switch information before forwarding the message. Revising time to switch information as such facilitates the process flow 300 for CAP 110, RE1, RE2, C1 and C2 to switch channel essentially at the same time, for example time step 309.

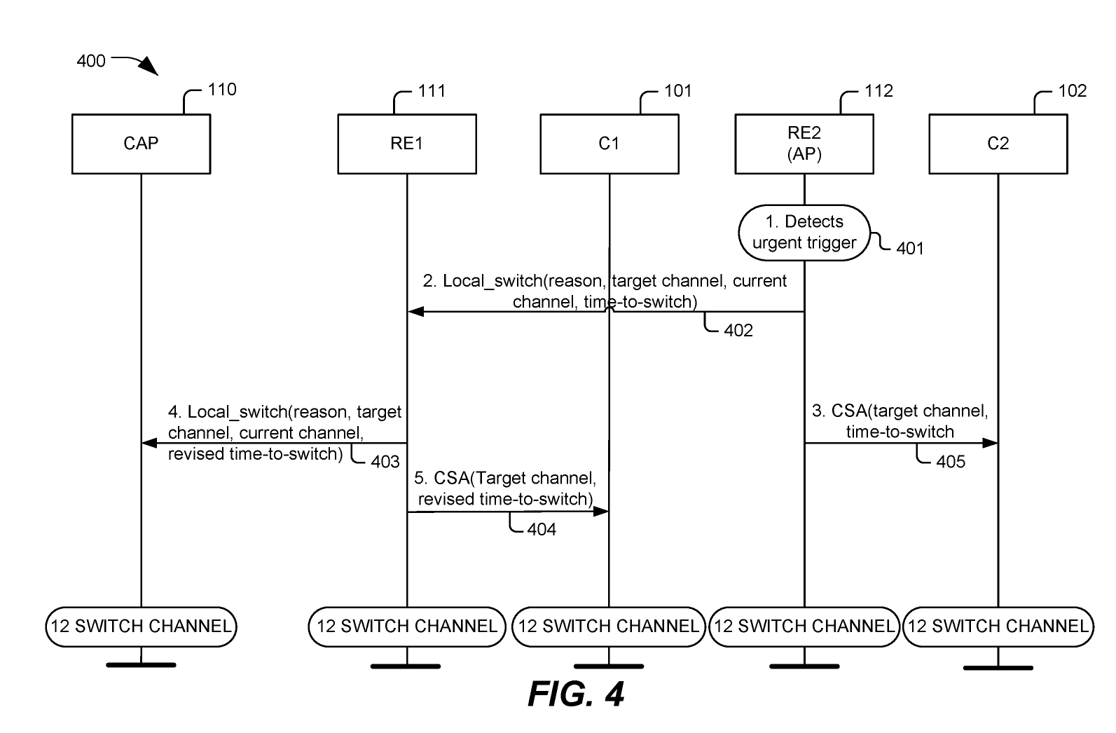

FIG. 4 depicts a process flow 400 for switching the serving channel when RE2 in an exemplary embodiment detects the need for an urgent switching of the channel. Considering RE2 is providing services to its associated client C2 102 on channel X, other entities operating for providing services on channel X in the network configuration 100 would also be impacted by such a possible urgent channel switch. In the exemplary embodiments of the network configuration 100 shown in FIG. 1, such other entities would include CAP 110, AP 111 (RE1), client 101 (C1), and client 102 (C2). RE2 detects the urgent trigger 401 for switching the channel. RE2 communicates to RE1 a local channel switch message 402 including the current and target channels information, and the time to switch the channel. RE1 would in turn communicate a revised local channel switch message 403 to CAP 110. The revised local channel switch message 403 includes a revised time to switch information as compared to the time to switch information included in message 402. The revised time in the message is for compensating time such that all the entities involved in the channel switch process could switch to the target channel at approximately the same time. RE2 also communicates to its associated client C2 a CSA message 405 with the target channel information and the time to switch the channel. RE1 would also communicate to its associated client C1 a CSA message 404 with the target channel information and a revised time to switch the channel as compared to the time to switch channel included in message 402. At this point, effectively, CAP 110, RE1, RE2, C1 and C2 could switch the serving channel to the new target channel in accordance with various aspects of the disclosure.

In the exemplary embodiment shown in FIG. 4, RE2 is considered in a downstream communication flow in relation to RE1. Similarly, RE1 is considered in an upstream communication flow in relation to RE2. In accordance with various aspects of the disclosure, when RE2 detects the urgent trigger 401 for switching the channel and communicates the local channel switch message 402 to RE1, the message 402 may be treated as a direction for urgent switching of the channel. The urgent trigger of the channel may be detected based on a number of factors. One such factor is the local medium utilization level as being detected by the RE. For example, RE2 may detect the medium utilization has reached a significantly high level (e.g. 90%). Another factor is a level of interference and the type of interference. For example, if RE2 detects the type of interference is from an entity operating in the RADAR frequency band, the detection may be considered as an urgent trigger.

The APs 111 and 112 (i.e. RE1 and RE2) may independently make background over the air measurement locally in the serving channel and non-serving channel frequencies in order to determine whether an urgent trigger for switching a serving channel is needed. In the example depicted and described in relation to FIG. 4, RE2 is shown to detect the urgent trigger to switch the channel. In another example, RE1 may detect the urgent trigger for switching the channel. Or, both the RE1 and RE2 may detect the urgent trigger for switching the channel at the same time or essentially the same time. The factors considered for detecting the urgent trigger by each RE (i.e. AP) may be different in a network configuration. Factors that may be considered without limiting may be: medium utilization level, number of APs on a given channel, utilized bandwidth of a channel, use of primary or secondary channels, the level, type and source of interference, and the general spectrum noise floor.

For example, background over the air frequency scan measurements on a channel can give an estimate of the instantaneous medium utilization on the channel by estimating the fraction of time the observed energy level on the channel is above a threshold. The number of APs operating on the channel can be inferred by passively listening for beacons over such a channel frequency. Non-WiFi type of interference can be detected by a spectral scan by running signal processing algorithms on raw IQ samples from a modem in the receiving device. Error pattern detection techniques can also be used to detect non-Wi-Fi interference where the lower layer packet errors are analyzed to identify certain patterns in the detection of the packet errors. Based on such error patterns, the AP may determine detection of different types of non-Wi-Fi interference. The periodicity of scan measurements on a channel may vary from time to time and may be different among the APs (i.e. RE's) in the network configuration. Typical periodicity of the measurements may range from a few tens of seconds to a few minutes. If the channel usage conditions in networks is not expected to change very rapidly, fewer measurements over a period of time may be needed. Conversely, in network configurations with dynamic channel utilization, more measurements over a period of time may provide a more accurate result. Based on one or more such measurements, in the exemplary embodiment shown and described in relation to FIG. 4, RE2 determines whether an urgent trigger is detected and follows the process 400 for switching to a new channel.

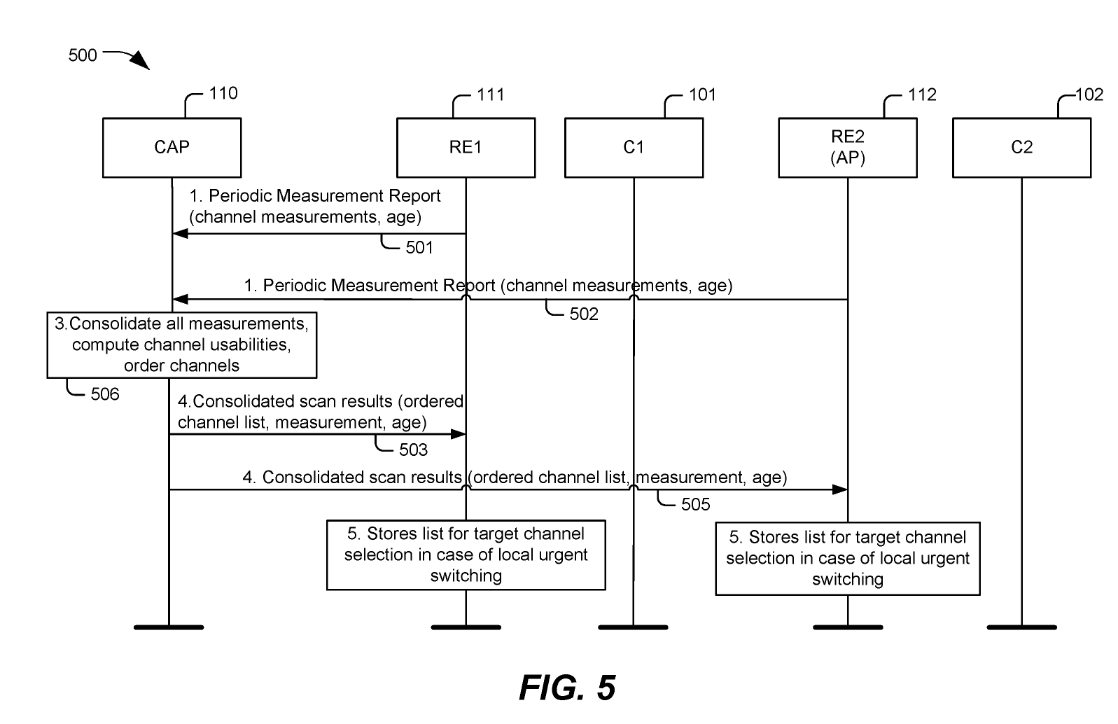

Selection of the target channel in an urgent channel switch may involve and be based on certain periodic measurements report communicated by the REs in the network configuration 100. FIG. 5 depicts a message flow 500 among the CAP 110, RE1 (i.e. AP 111) and RE2 (i.e. AP 112), in accordance with an exemplary embodiment of the disclosure for determination and selection of such a target channel in case there is a detection of urgent switch of the channel. Referring FIG. 5, RE1 and RE2 send periodic measurement reports 501 and 502 to CAP 110. Such reports may include information in regards to the profiles of certain related channel measurement, type of the measurements performed, certain indicators in terms of the interference levels, the channel identification, age of the measurement, medium utilization, etc. At step 506, CAP 110 consolidates and processes the measurement reports received from the RE's. The process for consolidation of the reports may involve ranking the usable channels. To prepare the consolidated report, CAP 110 in one example may use the medium utilization information communicated from all the RE's (i.e. AP's) and determine the utilization levels of a particular channel among the RE's. The consolidated report as a result may include an ordered list of channels such that over use of a particular channel among the RE's is avoided. Over use of a particular channel at an RE leads to excessive medium utilization of the channel and may create unnecessary failure of the service over the channel and unwanted interference. CAP 110 communicates messages 503 and 505 to RE1 and RE2 from time to time by including a consolidated report. The consolidated report sent to each RE may be the same or different. The consolidated report to each RE may include an ordered listed of channels to be used by the receiving RE for selection of a target channel in the event the RE detects an urgent trigger for switching the channel, as depicted and described in relation to various aspects of FIG. 4. The consolidated report may include an ordered list of the possible target channel based on the channel quality information reported from the RE's. The consolidated report may also include age information indicating when the report was generated and perhaps how long the report could be used by the receiving RE. In one example, if the report is expired at an RE, the RE may request receiving (not shown) a new consolidated report. Each RE may maintain an updated report. The report includes at minimum, a list of ordered channels for the RE to use in the event it detects an urgent trigger for switching the channel. The new channel is selected from the ordered list. RE1 and RE2 may each maintain a different list of ordered channel. The list maintained by each RE may be the same or overlap for certain number of ordered channels. The periodicity of updating the list at each RE may also be different. For example, CAP 110 may send an updated list of ordered channel to one RE more often than another. The periodicity of updating such list of ordered channel at each RE may be based on the profile of the periodic measurement report received by the CAP 110 from each RE. The number of periodic measurements sent to CAP 110 from each RE should be maintained at a level where adequate and up to date measurement reports are received by CAP 110 in order to generate a useful consolidated scan report with the ordered list of target channels. The frequency of sending such reports may be based on the dynamics of the network configuration. In a network where the clients are experiencing less tribulations in the received services, there is less need to have a high periodicity of such a reporting from CAP 110. If the reporting from the REs to CAP 110 indicate a more dynamic network environment, the REs may be sending their reporting more often and CAP 110 may also be sending its consolidated ordered scan report more often.

The non-urgent channel switching process flow 300 as depicted and described in relation to FIG. 3 and the urgent channel switching process flow 400 as depicted and described in relation to FIG. 4 may co-exist in the same network configuration such as network configuration 100. Considering that urgent channel switching at an RE (i.e. AP) may be detected because of an impending requirement to switch the channel very quickly, the process for urgent channel switch may take precedence over a non-urgent channel switching. For example, if an RE (i.e. AP) is in the process of switching the channel because it has detected an urgent trigger to switch the channel earlier, the RE may ignore the non-urgent channel switch direction generated by CAP 110 (e.g. CSA message 305 or 307). In another example, if an RE (i.e. AP) is preparing for the process of switching the channel because it has earlier received prep-message 301 from CAP 110 (i.e. a non-urgent direction to switch the channel), the RE may abort the preparation process if it detects an urgent trigger to switch the channel. The RE may follow the process for the urgent change of the channel based on its own locally detected urgent trigger to switch the channel. In the event the RE has sent the prep-complete message, such as prep-complete message 303 or 304, the RE may complete the process for switching the channel based on the direction from CAP 110 (i.e. receiving CSA message 305 or 307). After completing the process of switching the channel at time step 309, the RE may once again attempt to determine if an urgent channel switch is needed based on the condition of the newly changed channel.

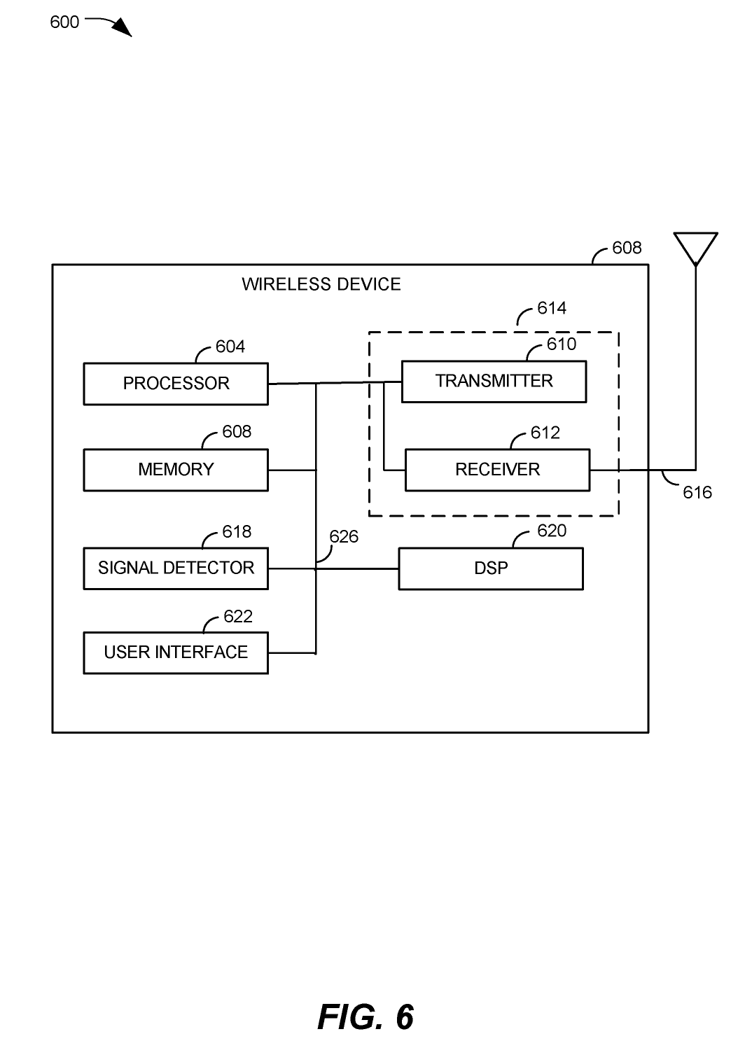

FIG. 6 illustrates a wireless device 602 with various components that may be utilized in any of the devices identified in FIGS. 1-5 that are able to perform wireless communication. For clarity, not all components are shown and there may also be some differences in complexity of implementation among such wireless devices. For example, CAP 110 may include several processors, larger memory and multiple transmitter and receivers as compared to client devices or the access points. The client devices may incorporate components that are able to perform limited functions to conserve power consumption whereas the access points and CAP 110 may not have such limitation as they may be connected to a power source. Considering such possible differences, wireless device 602 may be employed within any of the wireless devices identified in FIGS. 1-5. The wireless device 602 is an example of a device that may be configured to implement the various methods described herein. A number of interconnections among the components of the wireless device 602 is shown. However, in various implementation such interconnections may vary and there may be additional interconnections and additional components within wireless device 602.

The wireless device 602 may include a processor 604 which controls operation of the wireless device 602. The processor 604 may also be referred to as a central processing unit (CPU). Memory 606, which may include both read-only memory (ROM) and random access memory (RAM), provides instructions and data to the processor 604. A portion of the memory 606 may also include non-volatile random access memory (NVRAM). The processor 604 typically performs logical and arithmetic operations based on program instructions stored within the memory 606. The instructions in the memory 606 may be executable to implement the methods described herein. The processor 604 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 602 may also include a housing 608 that may include a transmitter 610 and a receiver 612 to allow transmission and reception of data between the wireless device 602 and a remote location. The transmitter 610 and receiver 612 may be combined into a transceiver 614. An antenna 616 may be attached to the housing 608 and electrically coupled to the transceiver 614. The wireless device 602 may also include (not shown) multiple transmitters, multiple receivers, multiple transceivers, and/or multiple antennas. The wireless device 602 may also include a signal detector 618 that may be used in an effort to detect and quantify the level of signals received by the transceiver 614. The signal detector 618 may detect such signals as total energy, energy per subcarrier per symbol, power spectral density and other signals. The wireless device 602 may also include a digital signal processor (DSP) 620 for use in processing signals. The DSP 620 may be configured to generate a data unit for transmission. In some aspects, the data unit may comprise a physical layer data unit (PPDU). In some aspects, the PPDU is referred to as a packet.

The wireless device 602 may further comprise a user interface 622 in some aspects. The user interface 622 may comprise a keypad, a microphone, a speaker, and/or a display. The user interface 622 may include any element or component that conveys information to a user of the wireless device 602 and/or receives input from the user. The various components of the wireless device 602 may be coupled together by a bus system 626. The bus system 626 may include a data bus, for example, as well as a power bus, a control signal bus, and a status signal bus in addition to the data bus. Those skilled in the art will appreciate the components of the wireless device 602 may be coupled together or accept or provide inputs to each other using some other mechanism.

Although a number of separate components are illustrated in FIG. 6, those skilled in the art will recognize that one or more of the components may be combined or commonly implemented. For example, the processor 604 may be used to implement not only the functionality described above with respect to the processor 604, but also to implement the functionality described above with respect to the signal detector 618 and/or the DSP 620. Further, each of the components illustrated in FIG. 6 may be implemented using a plurality of separate elements. The communications exchanged between devices in a wireless network may include data units which may comprise packets or frames. In some aspects, the data units may include three types of frames, including data frames, control frames, and management frames. Data frames may be used for transmitting data from one wireless device to another. Control frames may be used together with data frames for performing various operations and for reliably delivering data (e.g., acknowledging receipt of data, polling of APs, area-clearing operations, channel acquisition, carrier sensing maintenance functions, etc.). Management frames may be used for various supervisory functions (e.g., for joining and departing from wireless networks, etc.).

1. A method of wireless communication, comprising:
detecting a trigger to switch a serving channel at a first access point; and
communicating a first channel switch message from the first access point to a second access point.

2. The method of claim 1 wherein the first access point is in a downstream communication flow in relation to the second access point.

3. The method of claim 1 wherein the first access point is in an upstream communication flow in relation to the second access point.

4. The method as recited in claim 1 further comprising: communicating a second channel switch message from the first or second access point to a central access point, wherein the central access point is connected to wide area network for providing internet connectivity to a plurality of clients through a series of communication flows from the first and second access points.

5. The method as recited in claim 1, wherein at least one of the first and second access points is operating as a range extending access point.

6. The method of claim 4, further comprising: revising a time to switch channel information included in the first channel switch message, and including the revised time to switch channel information in the second channel switch message.

7. The method of claim 1, further comprising: communicating a first Channel Switching Announcement (CSA) message from the second access point to at least one client of the second access point, wherein the least one client is one of a plurality of clients receiving internet connectivity through a series of communication flows including a data flow through the second access point.

8. The method of claim 7, further comprising: revising a time to switch channel information included in the first channel switch message, wherein the first CSA message includes the revised time to switch channel information.

9. The method of claim 1, further comprising: communicating a second Channel Switching Announcement (CSA) message from the first access point to at least one client of the first access point, wherein the least one client is one of a plurality of clients receiving internet connectivity through a series of communication flows including a data flow through the first access point.

10. The method of claim 4, further comprising: switching from a serving channel to a target channel at essentially the same time at the central access point, the first and second access points, and the plurality of clients receiving internet connectivity through the series of communication flows.

11. The method of claim 4, further comprising: selecting a target channel to be included in the first channel switch message.

12. The method of claim 11, further comprising: communicating periodically channel measurements reports from the first and second access points to the central access point; consolidating the measurement reports at the central access point; and communicating a list of target channels to the first and second access points; wherein the selection of the target channel is based on one or more quality and preference metrics associated with the list of target channels.

13. The method of claim 4 further comprising:
communicating a prep-to-switch-channel-message from the central access point to at least one of the first and second access points;
detecting the trigger to switch the serving channel to be an urgent trigger to switch channel; and
rejecting the prep-to-switch-channel-message from the central access point by at least one of ignoring the prep-to-switch-channel-message and sending a reject prep-to-switch-channel-message.

14. The method of claim 9 further comprising: performing a band steering operation for at least a client being identified as a Channel Switching Announcement (CSA) un-friendly client at the first access point.

15. The method of claim 7 further comprising: performing a band steering operation for at least a client being identified as a Channel Switching Announcement (CSA) un-friendly client at the second access point.

16. The method of claim 4 further comprising:
communicating a prep-to-switch-channel-message from the central access point to at least one of the first and second access points; and
performing a band steering operation for at least a client being identified as a Channel Switching Announcement (CSA) un-friendly client at least one of the first access point and the second access point upon receiving the prep-to-switch-channel-message.

17. An apparatus for wireless communication, comprising:
a transceiver; and
a processor coupled with memory;
wherein the apparatus through at least one of the transceiver and the processor is configured to perform:
detecting a trigger to switch a serving channel at a first access point; and
communicating a first channel switch message from the first access point to a second access point.

18. The apparatus of claim 17 wherein the first access point is in a downstream communication flow in relation to the second access point.

19. The apparatus of claim 17 wherein the first access point is in an upstream communication flow in relation to the second access point.

20. The apparatus as recited in claim 17, wherein the apparatus through at least one of the transceiver and the processor is further configured to perform: communicating a second channel switch message from the first or second access point to a central access point, wherein the central access point is connected to wide area network for providing internet connectivity to a plurality of clients through a series of communication flows from the first and second access points.

21. The apparatus as recited in claim 17, wherein at least one of the first and second access points is operating as a range extending access point.

22. The apparatus of claim 20, wherein the apparatus through at least one of the transceiver and the processor is further configured to perform: revising a time to switch channel information included in the first channel switch message, and including the revised time to switch channel information in the second channel switch message.

23. The apparatus of claim 17, wherein the apparatus through at least one of the transceiver and the processor is further configured to perform: communicating a first Channel Switching Announcement (CSA) message from the second access point to at least one client of the second access point, wherein the least one client is one of a plurality of clients receiving internet connectivity through a series of communication flows including a data flow through the second access point.

24. The apparatus of claim 21, wherein the apparatus through at least one of the transceiver and the processor is further configured to perform: revising a time to switch channel information included in the first channel switch message, wherein the first CSA message includes the revised time to switch channel information.

25. The apparatus of claim 17, wherein the apparatus through at least one of the transceiver and the processor is further configured to perform: communicating a second Channel Switching Announcement (CSA) message from the first access point to at least one client of the first access point, wherein the least one client is one of a plurality of clients receiving internet connectivity through a series of communication flows including a data flow through the first access point.

26. The apparatus of claim 20, wherein the apparatus through at least one of the transceiver and the processor is further configured to perform: switching from a serving channel to a target channel at essentially the same time at the central access point, the first and second access points, and the plurality of clients receiving internet connectivity through the series of communication flows.

27. The apparatus of claim 20, wherein the apparatus through at least one of the transceiver and the processor is further configured to perform: selecting a target channel to be included in the first channel switch message.

28. The apparatus of claim 25, wherein the apparatus through at least one of the transceiver and the processor is further configured to perform: communicating periodically channel measurements reports from the first and second access points to a central access point; consolidating the measurement reports at the central access point; and communicating a list of target channels to the first and second access points; wherein the selection of the target channel is based on one or more quality and preference metrics associated with the list of target channels.

29. The apparatus of claim 20 wherein the apparatus through at least one of the transceiver and the processor is further configured to perform:
communicating a prep-to-switch-channel-message from the central access point to at least one of the first and second access points;
detecting the trigger to switch the serving channel to be an urgent trigger to switch channel; and
rejecting the prep-to-switch-channel-message from the central access point by at least one of ignoring the prep-to-switch-channel-message and sending a reject prep-to-switch-channel-message.

30. The apparatus of claim 25 wherein the apparatus through at least one of the transceiver and the processor is further configured to perform: performing a band steering operation for at least a client being identified as a Channel Switching Announcement (CSA) un-friendly client at the first access point.

31. The apparatus of claim 23 wherein the apparatus through at least one of the transceiver and the processor is further configured to perform: performing a band steering operation for at least a client being identified as a Channel Switching Announcement (CSA) un-friendly client at the second access point.

32. The apparatus of claim 20 wherein the apparatus through at least one of the transceiver and the processor is further configured to perform:
communicating a prep-to-switch-channel-message from the central access point to at least one of the first and second access points; and
performing a band steering operation for at least a client being identified as a Channel Switching Announcement (CSA) un-friendly client at the first access point or the second access point upon receiving the prep-to-switch-channel-message.
